(19) United States
(12) Patent Application Publication
(10) Pub. No.: US 2022/0342257 A1
(43) Pub. Date: Oct. 27, 2022

(54) DISPLAYS WITH SUB-PIXEL LIGHT SCATTERING

(71) Applicant: Hewlett-Packard Development Company, L.P., Spring, TX (US)

(72) Inventors: Hsing-Hung Hsieh, Taipei City (TW); Ann Alejandro Villegas, Spring, TX (US); Dehuei Chen, Taipei City (TW)

(73) Assignee: Hewlett-Packard Development Company, L.P., Spring, TX (US)

(21) Appl. No.: 17/765,288

(22) PCT Filed: Oct. 30, 2019
(86) PCT No.: PCT/US2019/058755

§ 371 Date: Mar. 30, 2022

(51) Int. Cl. G02F 1/1335

(52) U.S. Cl. CPC G02F 1/133504; G02F 1/133553; G02F 1/133514

(57) ABSTRACT

Example displays are disclosed that include a plurality of pixels, each pixel including a first sub-pixel and a set of second sub-pixels. In addition, the displays include a plurality of opaque structures aligned with the first sub-pixels, each opaque structure including a reflective surface to scatter light emitted from the first sub-pixels.

### BACKGROUND

Electronic displays are used in a variety of different ways and in a variety of different types of devices. For example, such displays are a component of devices such as televisions and computer monitors, and are integrally formed within other electronic devices such as, for example, laptop computers, tablet computers, all-in-one computers, smartphones, etc. The images and/or information projected by a display may include, for example, data, documents, textural information, communications, motion pictures, still images, etc. (all of these examples may be collectively referred to herein as “images”).

### BRIEF DESCRIPTION OF THE DRAWINGS

Various examples will be described below referring to the following figures:

FIGS. 1 and 2 are front and side views, respectively, of an electronic device including a display with a light scattering layer according to some examples;

FIG. 3 is a schematic cross-sectional view of a display with a light scattering layer according to some examples;

FIG. 4 is an enlarged schematic cross-sectional view of a pixel of a display with a light scattering layer according to some examples;

FIGS. 5 and 6 are enlarged schematic cross-sectional views of the display of FIG. 4 showing a direction of light emitted from different sub-pixels according to some examples;

FIG. 7 is a front view of an electronic device showing the directions of light scattered from a light scattering layer of a display of the electronic device according to some examples;

FIGS. 8-11 are bottom views of opaque structures that may be included within a light scattering layer of a display according to some examples; and

FIG. 12 is a schematic cross-sectional view of a display with a light scattering layer according to some examples.

### DETAILED DESCRIPTION

In the figures, certain features and components disclosed herein may be shown exaggerated in scale or in somewhat schematic form, and some details of certain elements may not be shown in the interest of clarity and conciseness. In some of the figures, in order to improve clarity and conciseness, a component or an aspect of a component may be omitted.

In the following discussion and in the claims, the terms “including” and “comprising” are used in an open-ended fashion, and thus should be interpreted to mean “including, but not limited to . . . .” Also, the term “couple” or “couples” is intended to be broad enough to encompass both indirect and direct connections. Thus, if a first device couples to a second device, that connection may be through a direct connection or through an indirect connection via other devices, components, and connections. In addition, as used herein, the terms “axial” and “axially” generally refer to positions along or parallel to a central or longitudinal axis (e.g., central axis of a body or a port), while the terms “radial” and “radially” generally refer to positions located or spaced to the side of the central or longitudinal axis.

As used herein, including in the claims, the word “or” is used in an inclusive manner. For example, “A or B” means any of the following: “A” alone, “B” alone, or both “A” and “B.” In addition, when used herein, including the claims, the words “generally,” “substantially,” “about,” or “approximately,” mean within a range of plus or minus 10% of the stated value.

As used herein, the term “electronic device,” refers to a device that is to carry out machine readable instructions, and may include internal components, such as, processors, power sources, memory devices, etc. For example, an electronic device may include, among other things, a personal computer, a smart phone, a tablet computer, a laptop computer, a personal data assistant, etc. As used herein, the term “display” refers to an electronic display (e.g., an organic light emitting diode (OLED) display, a liquid crystal display (LCD), a plasma display, etc.) that is to display images generated by an associated electronic device.

As previously described above, displays are utilized to project images and/or information (which are collectively referred to herein as “images”) for viewing by a viewer or plurality of viewers. In some instances, displays are used to project images that are considered confidential or sensitive. Thus, the intended or authorized viewer of the display may wish to limit the visibility of the images on the display to a select viewing position or positions relative to the display. Accordingly, examples disclosed herein include electronic displays that are to selectively restrict the visibility of the images projected thereby to viewing positions that are disposed at relatively large viewing angles.

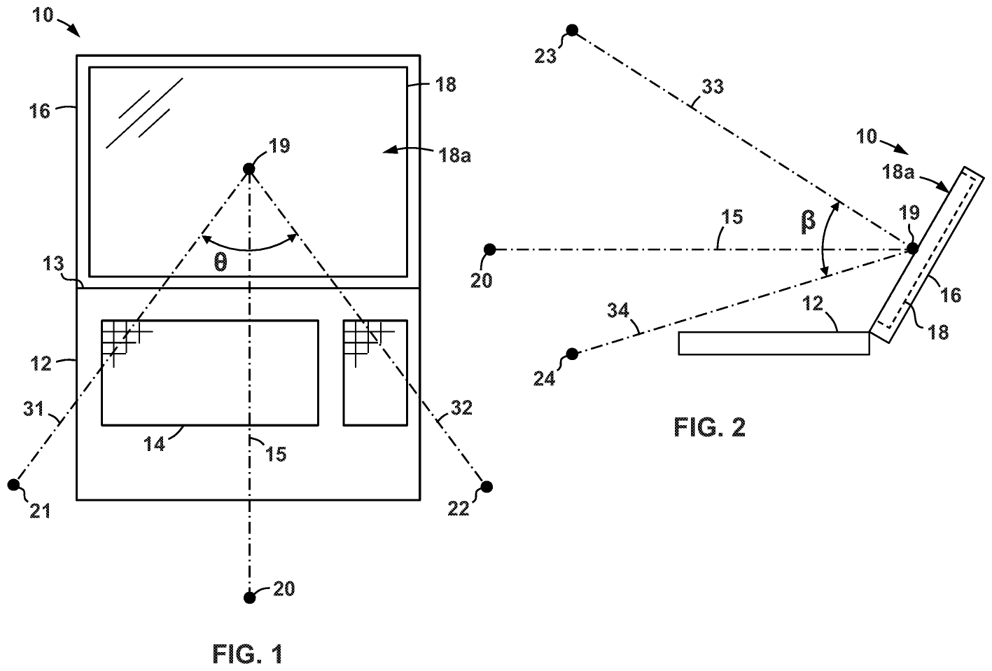

Referring now to FIGS. 1 and 2, an electronic device 10 according to some examples is shown. In this example, electronic device 10 is a laptop computer that includes a first housing member 12 rotatably coupled to a second housing member 16 at a hinge 13. The first housing member 12 includes an input device, such as, for example, a keyboard 14. The second housing member 16 includes an electronic display 18 (or more simply “display 18”) that is to project images out of an outer side or surface 18a for viewing by a viewer (not shown) of the electronic device 10.

A viewer may be positioned in front of the display 18 of electronic device 10 at a position 20. Position 20 may be disposed at or near a “zero-axis” position relative to display 18 so that position 20 is directly in front of display 18 (or nearly directly in front). In particular, position 20 may be disposed along an axis 15 that extends outward from a center 19 of display 18. Axis 15 may extend perpendicularly from the lateral span of display 18. Thus, position 20 may be referred to herein as front viewing position.

Display 18 may be viewable from other positions other than the front viewing position 20, such as viewing positions that are laterally and/or vertically shifted from the front viewing position 20. Therefore, display 18 defines a first viewing angle θ, and a second viewing angle β that extends perpendicular to the first viewing angle θ. Because first housing member 12 of electronic device 10 may be placed flat on a laterally oriented support surface (e.g., table, desk, etc.), the first viewing angle θ may be referred to herein as a “lateral viewing angle θ” and the second viewing angle β may be referred to herein as a “vertical viewing angle β” in the context of electronic device 10.

As best shown in FIG. 1, the lateral viewing angle θ may extend between a pair of off-axis viewing positions 21, 22 that are laterally shifted from the front viewing position 20. Off-axis viewing positions 21, 22 represent the most extreme positions to the left and right, respectively, from the display 18 from which a viewer may still see or discern the images projected therefrom. Viewing positions that are shifted laterally outside or beyond the positions 21, 22 may represent positions from which a viewer may no longer see or discern the images projected by display 18. Each viewing position 21, 22 may have a line of sight or axis 31, 32, respectively, extending between the positions 21, 22, respectively, and the center 19 of display 18. Together, the axes 15, 31, 32 define a first plane, and the first viewing angle θ extends within this plane between the axes 31, 32. Because first housing member 12 may be disposed on a lateral support surface during operations as previously described, the first plane defined by axes 15, 31, 32 may be a lateral plane.

As best shown in FIG. 2, the vertical viewing angle β may extend between a pair of off-axis viewing positions 23, 24 that are vertically shifted from the front viewing position 20. Off-axis viewing positions 23, 24 represent the most extreme positions above and below, respectively, from the display 18 from which a viewer may still see or discern the image projected therefrom. Viewing positions that are shifted vertically outside or beyond the positions 23, 24 may represent positions from which a viewer may no longer see or discern the images projected by display 18. Each viewing position 23, 24 may have a line of sight or axis 33, 34, respectively, extending between the positions 23, 24, respectively, and the center 19 of display 18. Together, the axes 15, 33, 34 define a second plane, and the second viewing angle β extends within this plane between the axes 33, 34. As shown in FIGS. 1 and 2, the second plane defined by axes 15, 33, 34 is perpendicular to the first plane defined by axes 15, 31, 32. In addition, because first housing member 12 may be disposed on a lateral support surface during operations as previously described, the second plane defined by axes 15, 33, 34 may be a vertically oriented plane.

As will be described in more detail below, display 18 is to selectively adjust or limit the viewing angles θ, β of display 18 so as to provide selective privacy from off-axis viewers that are vertically and/or laterally adjacent to the front viewing position 20. This function and specific example structures of display 18 will now be described in more detail below.

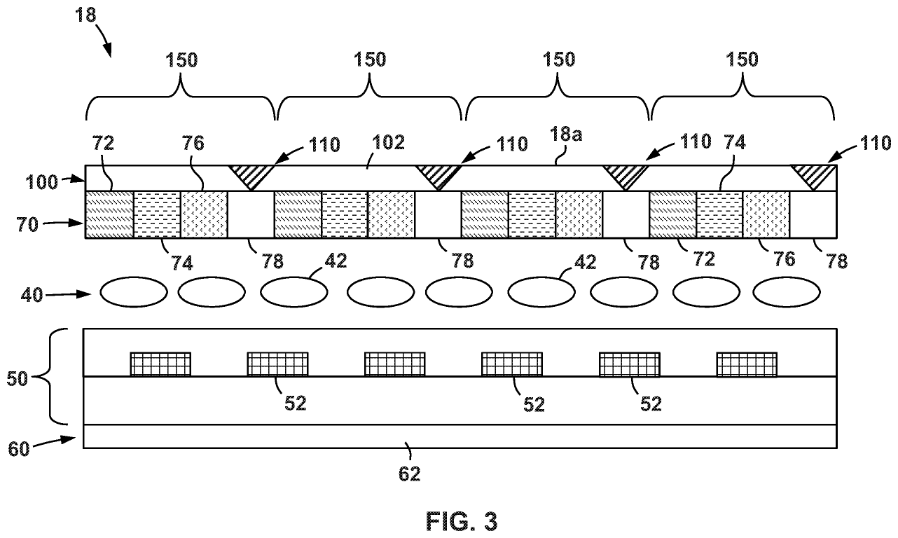

Referring now to FIG. 3, an example of display 18 for use within electronic device 10 (see FIGS. 1 and 2) is shown. In this example, display 18 is an LCD-type display that includes a color filter 70, a liquid crystal layer 40, a thin-film transistor (TFT) 50, and a backlight assembly 60. In the following discussion, various components and features of display 18 are described. However, the components making up display 18 may not be limited to those discussed or shown herein. Rather, other components, layers, features, etc., may be included or incorporated into the display 18 in addition to those specifically discussed or shown herein. These additional, potential features of display 18 are not specifically depicted or discussed herein to promote the conciseness and brevity of this description.

Backlight assembly 60 includes a light source 62 (which may also be referred to as a backlight) that is to generate light for transmission through the other components of display 18 during operations. Any suitable source of light may be used within light source 62 such as, for example, light emitting diodes (LED), incandescent bulbs, fluorescent lighting etc. In addition, while not specifically shown, in some examples, backlight assembly 60 may include a light guide or other suitable device for directing the light emitted from light source 62 toward the outer surface 18a of the display 18.

TFT 50 includes a plurality of pixel electrodes 52 organized in a series of rows and columns across a surface area of display 18. Each pixel electrode 52 may be selectively energized with electric current so as to induce a local electric field that applies a differential voltage to nearby objects or components. As previously described above, TFT 50 may include a plurality of other components (e.g., common electrode(s), polarizer(s), substrate(s), etc.); however, these additional features are not shown in FIG. 3 in the interest of brevity.

Liquid crystal layer 40 includes a plurality of liquid crystal molecules 42. The liquid crystal molecules 42 may be generally elongated in shape, and may change their orientation based on a surrounding magnetic or electric field (e.g., such as a differential voltage generated within an electric field). Thus, as will be described in more detail below, the orientation of liquid crystal molecules 42 may be selectively changed by applying a differential voltage across the liquid crystal layer 40. Any suitable liquid crystal material may be used to make up liquid crystal layer 40.

During operations, the differential voltages generated by the local electric fields of selectively energized pixel electrodes 52 cause liquid crystal molecules 42 within liquid crystal layer 40 to assume predetermined orientations. For example, in some instances, when select pixel electrodes 52 are energized, the liquid crystal molecules 42 that are proximate the energized pixel electrodes 52 are oriented so as to allow light to pass through liquid crystal layer 40 at preselected brightness levels. The electrical current provided to the select pixel electrodes 52 may be varied in order to cause a corresponding change in the orientation of the local liquid crystal molecules 42. As a result, an image may be formed by selectively altering the contrast of light that passes through the liquid crystal layer 40.

Referring still to FIG. 3, light that passes through the liquid crystal layer 40 is then directed across color filter 70. Color filter 70 includes a plurality of color filter cells that are each to filter to a specific color of light. For instance, in this example, the color filter cells within color filter 70 include a repeating pattern of red cells 72, green cells 74, blue cells 76, and white cells 78. A grouping of adjacent red cells 72, green cells 74, blue cells 76, and white cells 78 may be referred to as a pixel 150. Thus, within each such pixel 150 of display 18, the red cells 72 may be referred to herein as red sub-pixels 72, green cells 74 may be referred to herein as green sub-pixels 74, blue cells 76 may be referred to herein as blue sub-pixels 76, and white cells 78 may be referred to as white sub-pixels 78. Without being limited to this or any other theory, the color filter cells 72, 74, 76, 78 (or sub-pixels 72, 74, 76, 78) are to allow light of the corresponding color (e.g., red, green, blue, white, respectively) to pass through and to absorb light of different colors. Thus, the red sub-pixels 72 allow red colored light to pass through, while absorbing light of other shades; the green sub-pixels 74 allow green colored light to pass through, while absorbing light of other shades; and so on. Thus, each red sub-pixel 72, green sub-pixel 74, blue sub-pixel 76, and white sub-pixel 78 may emit red, green, blue, and white colored light, respectively, and combinations of light from the red, green, blue, white sub-pixels 72, 74, 76, and 78, respectively, may be combined to create a multitude of other colors and shades.

A light scattering layer 100 is disposed over the color filter 70. In some examples, the light scattering layer 100 may be disposed directly on top of the color filter 70, or may be disposed atop a layer or component (e.g., polarizers, substrates, etc.) that is disposed atop color filter 70. Regardless, in some examples, the light scattering layer 100 is to receive light emitted through the color filter 70 during operations. In some examples, light scattering layer 100 may form the outer surface 18a of display 18; however, in some examples, other layers may be disposed on top of light scattering layer 100 that form the outer surface 18a of display 18.

Light scattering layer 100 generally includes a transparent (or semi-transparent) substrate 102 and a plurality of opaque structures 110 embedded or suspended within the substrate 102. Substrate 102 may comprise any suitable, transparent or semi-transparent material, such as, for instance, a polymer, resin, or combination thereof. The opaque structures 110 may be distributed and arranged within the substrate 102 so as to be aligned with select sub-pixels (e.g., sub-pixels 72, 74, 76, 78, etc.) of the pixels 150 of display 18. For instance, in this example, the opaque structures 110 are each aligned with the white sub-pixels 78 of each pixel 150 of display 18. In addition, in some examples (e.g., such as the example of FIG. 3), the opaque structures 110 are aligned with all of the white sub-pixels 78 of display 18. However, in other examples, opaque structures 110 are aligned with less than all of the white sub-pixels 78 (or some other sub-pixel) of display 18.

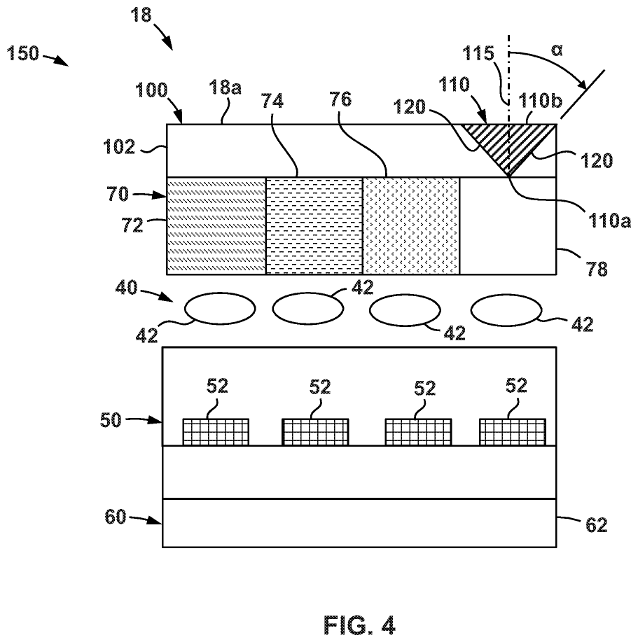

Reference is now made to FIG. 4, which shows one pixel 150 of display 18 in more detail. In the depiction of FIG. 4, one of the opaque structures 110 of light scattering layer 100 is aligned with the white sub-pixel 78 of pixel 150. Further details of the opaque structure 110 of FIG. 4 are now described; however, the following description may also be applied to describe the other opaque structures 110 shown in the example of FIG. 3.

Generally speaking, the opaque structure 110 includes a central axis 115 that may extend normally or perpendicularly to outer surface 18a of display 18, a first or inner end 110a, and a second or outer end 110b opposite inner end 110a along axis 115 so that inner end 110a is more proximate color filter 70 than outer end 110b. In addition, opaque structure 110 includes a plurality of reflective surfaces 120 extending between the inner end 110a and the outer end 110b. In particular, in some examples, the reflective surfaces 120 may be angled so as to generally flare radially away from central axis 115 when moving axially from inner end 110a to outer end 110b, so that reflective surfaces 120 may extend at an angle α relative to central axis 115. In some examples, the angle α may be greater than 0° and less than 90°, such as for instance, from about 30° to about 60°, or from about 33° to about 55°. However, other values and ranges for the angle α are contemplated herein. In addition, in some examples, the reflective surfaces 120 may each be oriented at the same angle α; however, in other examples, some or all of the reflective surfaces 120 may extend at different angles α. As will be described in more detail below, the reflective surfaces 120 may reflect light emitted through the white sub-pixel 78 outward toward the edges of the display 18 so as to reduce the contrast for images emitted from display 18 for viewers who are disposed at relatively large viewing angles (e.g., large values of the lateral viewing angle θ and/or the vertical viewing angle β as previously described above). Accordingly, opaque structures 110 may also be referred to herein as opaque reflective structures 110 or reflective structures 110.

Reflective surfaces 120 may be sufficiently reflective to reflect most or substantially all light that is directed thereto. For instance, in some examples, the reflective surfaces 120 may have a reflectance (which is a ratio of reflected light to incident light) of greater than 50%, such as, for instance, greater than 75%, greater than 90%, etc. In some examples, the reflective surfaces 120 may comprise a metallic material or layer. For instance, in some examples, the opaque structure 110 may comprise (in whole or in part) a metallic material.

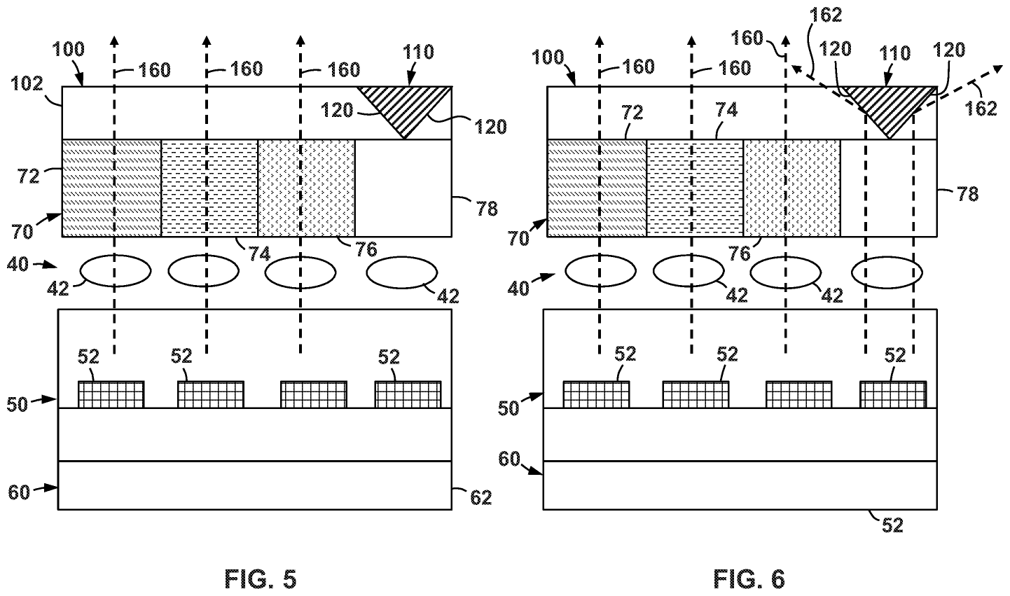

Referring now to FIG. 5, during operations light 160 is generated by the light source 62 that is emitted through thin-film transistor 50 to liquid crystal layer 40. The pixel electrodes 52 may be energized so as to selectively change the orientation of the liquid crystals 42 within liquid crystal layer 40, and thereby allow a desired amount of light to be emitted from the sub-pixels 72, 74, 76. The combined light emitted from the sub-pixels 72, 74, 76 may then be combined with the light of other pixels 150 of display 18 to thereby form a colored image that may be visible to a viewer. When additional privacy is not desired (e.g., such as when the display 18 is being operated in a non-private viewing mode), light is prevented (or restricted) from passing through the liquid crystal layer 40 to the white sub-pixels 78, so that substantially all of the light emitted from outer surface 18a of display 18 is emitted from the red sub-pixels 72, the green sub-pixels 74, and the blue sub-pixels 76. Thus, with brief reference again to FIGS. 1 and 2, when display is operated in the non-private viewing mode shown in FIG. 5, the lateral and/or vertical viewing angles θ and/or β may be set to a maximum value.

Referring now to FIG. 6, if a user wishes to limit the viewability of the images projected from display 18, light 162 may be emitted through the liquid crystal layer 40 toward the white sub-pixels 78 (e.g., by selective energization of the pixel electrodes 52 in TFT 50 as previously described). However, the light 162 that is directed through the white sub-pixels 78 is blocked from being emitted normally or perpendicularly out of the outer surface 18a of display 18 by the opaque structures 110. Rather, the light 162 is reflected outward at relatively large angles (e.g., such as generally toward the edges of the display 18). Therefore, viewers disposed at relatively extreme side and/or vertical positions may no longer discern the images projected from display 18 due to the scattered light from white-subpixels 78. In particular, a viewer who is disposed at a relatively large viewing angle (e.g., such as for large values of the lateral viewing angle θ and/or the vertical viewing angle β as previously described above) may be overwhelmed by the scattered white light, so that images projected toward such wide angle viewers from the display 18 may have a drastically reduced contrast. Thus, referring briefly again to FIGS. 1 and 2, when display 18 is operated in the private viewing mode shown in FIG. 6, the lateral and/or vertical viewing angles θ and/or β may be reduced or limited to enhance privacy for the displayed images.

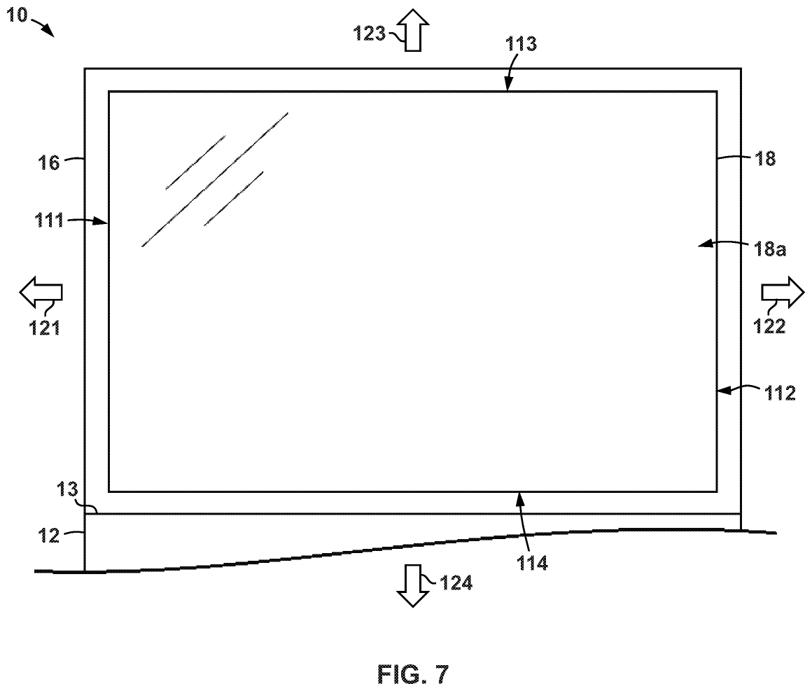

Referring now to FIGS. 6 and 7, in some examples, the reflective surfaces 120 may be arranged on the opaque structures 110 so as to reflect light (e.g., light 162 shown in FIG. 6) emitted through the white sub-pixels 78 toward the left and right edges 111 and 112, respectively, of display 18 (or generally along directions 121 and 122, respectively). In some examples, the reflective surfaces 120 of opaque structures 110 may be arranged so as to reflect light emitted through the white sub-pixels 78 toward the top and bottom edges 113 and 114, respectively, of display 18 (or generally along directions 123 and 124, respectively). As will be described in more detail below, in some examples the reflective surfaces 120 may be arranged so as to reflect light toward either or both the left and right edges 111 and 112, respectively, and the top and bottom edges 113 and 114, respectively. Referring briefly now to FIGS. 1 and 7, if light is reflected (or scattered) by the reflective surfaces 120 in the directions 121, 122 toward edges 111, 112, respectively, the lateral viewing angle θ may be limited or reduced. Conversely, if light is reflected (or scattered) by the reflective surfaces 120 in the directions 123, 124 toward edges 113, 114, respectively, the lateral viewing angle β may be limited or reduced.

Light that is reflected by reflective surfaces 120 toward edges 111, 112, 113, 114 of display 18 may be directed at an angle to the direction of the central axis 115 of the opaque structure 110 that is generally greater than 0° and less than 90°. Accordingly, as used herein, light that is said to be reflected “toward” an edge or edges of the display refers to light that has a direction having both an axial component (e.g., along an axis extending normally to a front surface of the display) and a lateral component (e.g., along a radius of an axis extending normally to the front surface of the display).

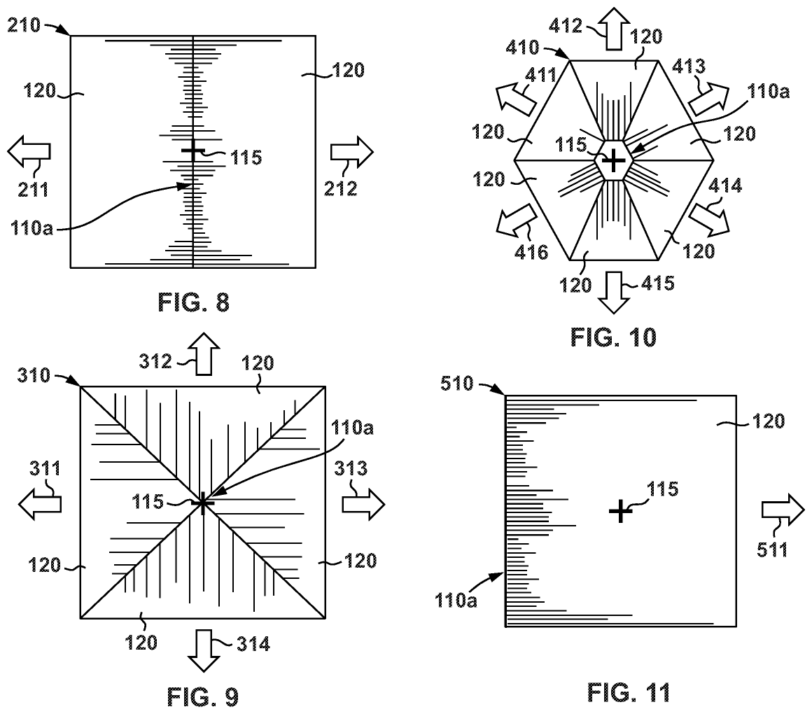

As previously described above, the opaque structures 110 and reflective surfaces 120 may be formed in a variety of different shapes and/or arrangements in various examples. For instance, reference is now generally made to FIGS. 8-11 which show a number of different potential designs of the opaque structures 110 that may be included within light scattering layer 100 of display 18 (see e.g., FIG. 3). Without being limited to this or any other theory, the different designs of opaque structures 110 may be intended to reflect light to different locations or edges of display 18 during operations (see e.g., directions 111, 112, 113, 114 of display 18 in FIG. 7). So as to modify or adjust the lateral viewing angle θ and/or the vertical viewing angle β as previously described.

In addition, while a number of example designs are discussed below with reference to FIGS. 8-11, these specific examples do not provide all the potential arrangements or designs of the opaque structures 110 or reflective surfaces 120. Thus, the specific examples discussed below should not be interpreted as limiting the potential designs for opaque structures 110 and reflective surfaces 120.

Referring first to FIG. 8, an example of an opaque structure 210 is shown that may be utilized as some or all of the opaque structures 110 for display 18 (e.g., in FIG. 3). In this example, opaque structure 210 is shaped as a triangular prism and therefore includes a pair (e.g., two) of reflective surfaces 120 extending opposite one another so as to reflect light in two opposing directions 211, 212. Referring now to FIGS. 7 and 8, when opaque structure 210 is utilized as some or all of the opaque structures 110 in display 18, the orientation of the opaque structures 210 may be set so as to reflect light in either the opposing directions 121, 122 or the opposing directions 123, 124. In some examples, a first portion of the opaque structures 210 may be arranged to reflect light in the directions 121, 122 and second portion of the opaque structures 210 may be arranged to reflect light in the directions 123, 124.

Referring now to FIG. 9, another example of an opaque structure 310 is shown that may be utilized as some or all of the opaque structures 110 for display 18 (e.g., in FIG. 3). In this example, opaque structure 310 is shaped as a pyramid (e.g., a regular square pyramid) and therefore includes four reflective surfaces 120 to reflect light in four directions 311, 312, 313, 314. The directions 311, 313 are opposite on another, the directions 312, 314 are opposite one another, and the directions 311, 312 are rotated approximately 90° from the directions 313, 314 about central axis 115. Referring now to FIGS. 7 and 9, in some examples, when opaque structure 310 is utilized as some or all of the opaque structures 110 in display 18, light may be reflected in toward the left edge 111, right edge 112, top edge 113, and bottom edge 114, simultaneously, by each reflective surface 120 of opaque structure 310.

Referring now to FIG. 10, another example of an opaque structure 410 is shown that may be utilized as some or all of the opaque structures 110 for display 18 (e.g., in FIG. 3). In this example, opaque structure 410 is shaped as a truncated hexagonal pyramid and therefore includes six reflective surfaces 120 to reflect light in six directions 411, 412, 413, 414, 415, 416, wherein each reflective surface 120 is rotated about 60° from each immediately angularly adjacent reflective surface 120 about central axis 115. Referring now to FIGS. 7 and 10, when opaque structure 410 is utilized as some or all of the opaque structures 110 in display 18, light may be reflected in toward the left edge 111, right edge 112, top edge 113, and bottom edge 114, simultaneously, by the reflective surfaces 120 of each opaque structure 410. a similar reflection pattern as discussed above for the opaque structure 410 may be achieved with a non-truncated hexagonal pyramid shaped opaque structure in some examples.

Referring now to FIG. 11, another example of an opaque structure 510 is shown that may be utilized as some or all of the opaque structures 110 for display 18 (e.g., in FIG. 3). In this example, opaque structure 510 is shaped as a right triangular prism and therefore includes one surface 120 to reflect light in a single direction 511. Referring now to FIGS. 7 and 11, when opaque structure 510 is utilized as some or all of the opaque structures 110 in display 18, the orientation of the opaque structures 510 may be set so as to reflect light in either, all, or some combination of the directions 121, 122, 123, 124. For instance, in some examples a first portion of the opaque structures 510 may be arranged to reflect light in the direction 121, a second portion of the opaque structures 510 may be arranged to reflect light in the direction 122, a third portion of the opaque structures 510 may be arranged to reflect light in the direction 123, and a fourth portion of the opaque structures 510 may be arranged to reflect light in the direction 124. In some examples, the opaque structures 510 may be arranged to reflect light in the directions 121, 122 (e.g., with a first portion of the opaque structures 510 reflecting light in the direction 121, and a second portion of the opaque structures 510 reflecting light in the direction 122). In some examples, the opaque structures 510 may be arranged to reflect light in the directions 123, 124 (e.g., with a first portion of the opaque structures 510 reflecting light in the direction 123, and a second portion of the opaque structures 510 reflecting light in the direction 124).

In some examples, the reflective surface 120 (or some of the reflective surfaces 120) may be curved (e.g., concavely, convexly, etc.). For instance, in some examples, the opaque structure may comprise a dome-shaped structure including a hemispherical or elliptical curved reflective surface 120. As another example, in some instances, the opaque structures 110 may be conically shaped and therefore include a conically or frustoconically shaped reflective surfaces 120.

While the light scattering layer 100 (including the opaque structures 110) has been described as being used within an LCD display (e.g., display 18), in some examples light scattering layer 100 may be utilized on a variety of different display types (e.g., an OLED display, a plasma display, an electrophoretic display, etc.). For instance, in some examples, the light scattering layer 100 (including the opaque structures 110) is utilized on or within an OLED display.

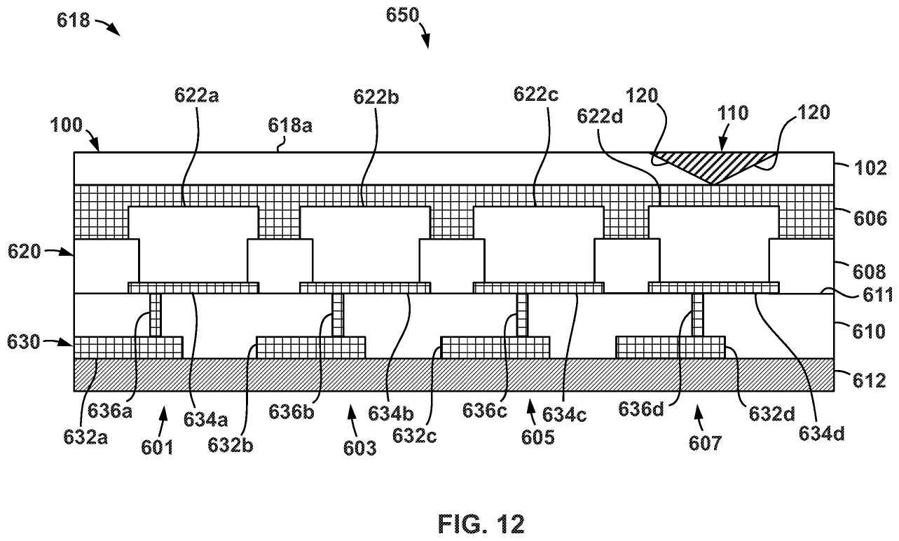

Referring now to FIG. 12, an example of display 618 for use within electronic device 10 of FIGS. 1 and 2 is shown. Generally speaking, display 618 is an OLED display that includes a TFT 630, an OLED assembly 620, and a light scattering layer 100 (which includes opaque structures 110 as described above). The OLED assembly 620 may be disposed atop the TFT 630, and the light scattering layer 100 may be disposed atop the OLED assembly 620. In addition, display 618 may include a plurality of pixels 650 arranged in a plurality of columns and rows, and each pixel 650 may include a plurality of sub-pixels associated with a plurality of colors. FIG. 12 shows one pixel 650 of display 18, which comprises a total of four sub-pixels 601, 603, 605, 607. Sub-pixels 601, 603, 605, 607 may emit a specific color, such as, red, green, blue, white, respectively, in this example. During operations, different ones or combinations of the sub-pixels 601, 603, 605, 607 may emit the colored light so as to provide a desired color from the pixel 650 which (along with the other pixels 650 of the display 618) thereby forms an image that is emitted or projected from an outer surface 618a of display 618 as previously described. In this example, light scattering layer 100 forms the outer surface 618a of display 618. However, in other examples, additional layer(s) and/or component(s) may be disposed on top of the light scattering layer 100, such that these additional layer(s) and component(s) may form the outer surface 618a.

Generally speaking, TFT 630 includes a substrate 612 and a plurality of sub-pixel electrodes 632a, 632b, 632c, 632d mounted to the substrate 612. Each sub-pixel electrode 632a, 632b, 632c, 632d is associated with a corresponding pixel of display 618. Because FIG. 12 depicts a one pixel 650 of display 618 as previously described, the four sub-pixel electrodes 632a, 632b, 632c, 632d associated with this depicted pixel 650 are shown. Each sub-pixel electrode 632a, 632b, 632c, 632d may be selectively energized with electric current, and thus may comprise any suitable conductive material(s) (e.g., indium-tin-oxide). In some examples, TFT 630 may comprise a low-temperature polycrystalline silicon (LTPS) TFT, an oxide TFT, an organic TFT, or any other suitable TFT structure.

In addition, TFT 630 includes a plurality of leads or connectors 636a, 636b, 636c, 636d that are electrically coupled to the sub-pixel electrodes 632a, 632b, 632c, 632d, respectively. Thus, during operations, electrical current that is provided to the sub-pixel electrodes 632a, 632b, 632c, 632d may be conducted to connectors 636a, 636b, 636c, 636d, respectively. Further, a preservation layer 610 may be applied on top of the substrate 612 and about the sub-pixel electrodes 632a, 632b, 632c, 632d and connectors 636a, 636b, 636c, 636d. In some examples, preservation layer 610 is an electrically insulating material, and thus, during operations, electrodes 632a, 632b, 632c, 632d are electrically insulated from one another, and connectors 636a, 636b, 636c, 636d are electrically insulated from one another via preservation layer 610. In addition, connectors 636a, 636b, 636c, 636d are electrically insulated from non-corresponding sub-pixel electrodes 632a, 632b, 632c, 632d via preservation layer 610. Specifically, connector 636a is electrically insulated from sub-pixel electrodes 632b, 632c, connector 636b is electrically insulated from sub-pixel electrodes 632a, 632c, and connector 636c is electrically insulated from sub-pixel electrodes 632b, 632c all via preservation layer 610.

Preservation layer 610 may comprise any suitable electrically insulating material, such as, for instance, a polymer. In various examples, preservation layer 610 may be opaque, translucent, or transparent. In some examples, the preservation layer 610 may be poured or deposited on top of substrate 612, sub-pixel electrodes 632a, 632b, 632c, 632d, and connectors 636a, 636b, 636c, 636d in a liquid or semi-liquid state prior to drying and/or curing. Once dry and/or cured, the preservation layer 610 may form a relatively flat or planar upper surface 611.

TFT 630 may include a plurality of other components (e.g., common electrode(s), polarizer(s), substrate(s), etc.). However, these additional features are not shown in FIG. 12 in the interest of brevity.

OLED assembly 620 includes a plurality of sub-pixel anodes 634a, 634b, 634c, 634d, a plurality of OLEDs 622a, 622b, 622c, 622d and, a common cathode 606. The sub-pixel anodes 634a, 634b, 634c, 634d are disposed on planar upper surface 611 of preservation layer 610. In addition, the OLEDs 622a, 622b, 622c, 622d are coupled to and disposed atop the sub-pixel anodes 634a, 634b, 634c, 634d, and the common cathode 606 is coupled to and disposed atop the OLEDs 622a, 622b, 622c, 622d. Sub-pixel anodes 634a, 634b, 634c, 634d are electrically coupled to connectors 636a, 636b, 636c, 636d, respectively. Thus, sub-pixel anodes 634a, 634b, 634c, 634d are electrically coupled to sub-pixel electrodes 622a, 622b, 622c, 622d via connectors 636a, 636b, 636c, 636d, respectively.

Sub-pixel anodes 634a, 634b, 634c, 634d may comprise an opaque electrically conductive material in some examples. For instance, sub-pixel anodes 634a, 634b, 634c, 634d may comprise aluminum, silver, or other metal alloys (e.g., such as those described herein). In addition, connectors 636a, 636b, 636c, 636d may also comprise an electrically conductive material (e.g., any of the metals or metal alloys mentioned above).

Common cathode 606 may comprise a sheet or layer (or multiple sheets or layers) of conductive materials that are to conduct electrical current therethrough during operations. In some examples, cathode 606 is semi-transparent so that the images or information projected by the corresponding display (e.g., display 618) are not blocked or substantially obstructed by cathode 606. In some examples, the cathode 606 may comprise an electrically conductive material, such as, for instance, indium-tin-oxide, indium-zinc-oxide, aluminum, silver, magnesium, or a combination thereof. However, other materials are also contemplated herein for cathode 606 in other examples. In addition, cathode 606 extends over all pixels of display 618, and thus is referred to herein as a “common” cathode 606.

During operations, electrical current may be supplied to the common cathode 606 and select ones of the sub-pixel anodes 634a, 634b, 634c, 634d (e.g., via the sub-pixel electrodes 632a, 632b, 632c, 632d and connectors 636a, 636b, 636c, 636d, respectively). The electrical current may then flow across the OLEDs 622a, 622b, 622c, 622d which thereby induces the OLEDs 622a, 622b, 622c, 622d to emit light. Specifically, as previously described above, each OLED 622a, 622b, 622c, 622d may emit a different shade or color of light. In some examples, OLED 622a may emit a red light, OLED 622b may emit a green light, OLED 622c may emit a blue light, and OLED 622d may emit a white light. Different combinations of the colored lights emitted from OLEDs 622a, 622b, 622c may be combined to generally emit a combined color of light from the overall pixel (e.g., the pixel collectively formed by sub-pixels 601, 603, 605, 607). The light emitted from the pixels of display 618 (one of which being depicted in FIG. 12) may then be combined to form an image for viewing.

Referring still to FIG. 12, an insulation layer 608 may be disposed about the sub-pixel anodes 634a, 634b, 634c, 634d and partially about OLEDs 622a, 622b, 622c, 622d. The insulation layer 608 may comprise an electrically insulating material, and may comprise the same material forming preservation layer 610 (previously described). Thus, the same description above for the preservation layer 610 may be applied to describe insulation layer 608 as well. During operations, insulation layer 608 may function to electrically insulate the sub-pixel anodes 634a, 634b, 634c, 634d from one another. In addition, as is also described above for the preservation layer 610, insulation layer 608 may be applied to sub-pixel anodes 634a, 634b, 634c, 634d and about OLEDs 622a, 622b, 622c, 622d in a liquid or semi-liquid state.

Light scattering layer 100 is disposed over the common cathode 606 so that the opaque structures 110 (which may comprise the example opaque structures 210, 310, 410 and/or 510 in FIGS. 8-11 as previously described above) are aligned with select ones of the sub-pixels 601, 603, 605, 607. For instance, in this example, the opaque structures 110 (one of which is shown in FIG. 12) are aligned with the sub-pixel 607, which generates white light via OLED 622d as previously described. Thus, during operations, white light may be selectively generated within OLED 622d and scattered by the reflective surface(s) 120 of opaque structures 110 as previously described. Accordingly, the light scattering layer 100 may selectively provide enhanced privacy from viewers disposed at relatively wide angles to display 618 as previously described above for LCD display 18 in FIG. 3.

While some examples disclosed herein have described a display for use within an electronic device (e.g., displays 18, 618 and electronic device 10), other examples of a display including a light scattering layer according to examples disclosed herein may be included within a computer monitor, television, or other display device that may not be considered an electronic device as described herein. In addition, while the opaque structures 110 have generally been described as being aligned with the white sub-pixels 78, 607 of the displays 18, 618 in FIGS. 4, 12, respectively, in other examples, the opaque structures 110 may be aligned with any of the other sub-pixels of the corresponding display (e.g., such as sub-pixels 72, 74, 76 for display 18 in FIG. 4 or sub-pixels 601, 603, 605 for display 618 of FIG. 12).

Therefore, through use of a light scattering layer (e.g., light scattering layer 100) including opaque structures (e.g., opaque structures 110) as described herein, a user may more adequately protect sensitive or confidential images projected by the display by selectively limiting the visible viewing angle(s) of the display during operations as previously described above. In particular, through use of the light scattering layers and opaque structures described herein, wide-angle viewers (that is, viewers disposed at relatively wide angles) may be prevented (or restricted) from seeing images projected from the display by the scattered light, thereby limiting the viewing angle(s) of the display when desired.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

1. A display, comprising:
a plurality of pixels, each pixel comprising a first sub-pixel and a set of second sub-pixels; and
a plurality of opaque structures aligned with the first sub-pixels, each opaque structure comprising a reflective surface to scatter light emitted from the first sub-pixels.

2. The display of claim 1, wherein the reflective surface of each opaque structure comprises a metallic material.

3. The display of claim 2, wherein the metallic material is selected from the group consisting of aluminum, silver, palladium, and copper.

4. The display of claim 1, wherein the reflective surface of each opaque structure extends at a non-zero angle α relative to an axis extending normally from an outer surface of the display.

5. The display of claim 4, wherein the angle α is less than 90°.

6. The display of claim 5, wherein the angle α ranges from about 30° to about 60°.

7. The display of claim 4, wherein each opaque structure comprises a plurality of reflective surfaces, wherein each reflective surface is disposed at the angle α.

8. The display of claim 7, wherein each opaque structure is shaped as one of a triangular prism or a pyramid.

9. The display of claim 7, wherein for each pixel, the first sub-pixel is to emit a white light, and the set of second sub-pixels are to emit colored light.

10. The display of claim 1, wherein the opaque structures are disposed within a transparent film that is disposed over the plurality of pixels.

11. A display, comprising:
a color filter defining a plurality of colored sub-pixels, and a plurality of white sub-pixels; and
a light scattering layer disposed on the color filter, the light scattering layer comprising a plurality of opaque, reflective structures aligned with the plurality of white sub-pixels that are to scatter light emitted from the plurality of white sub-pixels.

12. The display of claim 11, wherein the plurality of opaque, reflective structures are to reflect light toward an edge of the display.

13. The display of claim 12, wherein each opaque, reflective structure comprises a reflective surface that extends at a non-zero angle to an axis extending normally from an outer surface of the display.

14. A display, comprising:
a color filter defining a plurality of colored sub-pixels, and a plurality of white sub-pixels;
a backlight to emit light that is directed to a first side of the color filter; and
a plurality of reflective structures aligned with the white sub-pixels on a second side of the color filter that is opposite the first side, the reflective structures to reflect light emitted through the white sub-pixels toward an edge of the display.

15. The display of claim 14, wherein each reflective structure comprises a reflective surface that extends at a non-zero angle to an axis extending normally to an outer surface of the display.
